(19) United States
(12) Patent Application Publication
(10) Pub. No.: US 2008/0161038 A1
(43) Pub. Date: Jul. 3, 2008

(54) Intelligent mobile phone module

(75) Inventors: I-Yuan Lin, Taipei Hsien (TW); Jun Zhou, Shanghai (CN)

Correspondence Address: Joe McKinney Muncy, PO Box 1364, Fairfax, VA, 22038-1364, US

(73) Assignee: Inventec Appliances Corp.

(21) Appl. No.: 11/812,045

(22) Filed: Jun. 14, 2007

(30) Foreign Application Priority Data
Dec. 29, 2006 (TW) 95150016

(51) Int. Cl. H04M 1/00

(52) U.S. Cl. 455/552.1

(57) ABSTRACT

An intelligent mobile phone module is described. The intelligent mobile phone includes a main antenna, an assistant antenna, a switch, an RTR6275 chipset, a triplexer, and an RFR6500 chipset. The main antenna can receive and transmit quad-band GSM signals, CELL850 signals and PCS1900 signals. The assistant antenna can assist to receive the CELL850 signals, PCS1900 signals and GPS1500 signals. The switch is coupled to the main antenna for selecting a desired input or output signal for the main antenna. The triplexer is coupled to an assistant antenna for selecting a desired input signal for the assistant antenna.

### RELATED APPLICATIONS

This application claims priority to Taiwan Application Serial Number 95150016, filed Dec. 29, 2006, which is herein incorporated by reference.

### BACKGROUND OF THE INVENTION

1. Field of Invention

The invention relates to an intelligent mobile phone module and, in particular, to an intelligent mobile phone module with an assisted-GPS (A-GPS) function.

2. Related Art

The first generation (1G) mobile phone simply provides the voice conversation function. Although it has the ability of long-distance communications, its security is not good and it may be duplicated. Therefore, it has been phased out from the market. With progress in the technology, the second generation (2G) mobile phone can provide functions other than voice communications. Moreover, some additional and basic digital communication functions are defined to provide better security. The 2G mobile phone mainly uses a digital modulation system, including the European global system for mobile communications (GSM) standard and the American code division multiple access (CDMA) standard.

With higher demands in data transmissions, the third generation (3G) mobile phone puts more emphasis on the digital communications via broadband wireless telecommunications, in addition to simple voice conversions. Therefore, the mobile phone is able to enter the Internet world. A primary difference between the 2G mobile phone and the 3G phone is that the 3G mobile phone defines its minimum data transmission rate to be 144 kbps when it is in motion and 384 kbps when it is indoors. It mainly utilizes the CDMA as its core technology standard. Currently, 3GPP and 3GPP2 recognize three sets of 3G technology standards, the European WCDMA (Wideband Code Division Multiple Access) standard, the American CDMA2000 standard, and the Chinese TD-SCDMA (Time Division-Synchronous Code Division Multiple Access) standard.

Most of the traditional mobile phones on the market are dual-band or triple-band. The dual-band ones switch the frequency between 900 GHz and 1800 GHz, whereas the triple-band ones switch among 900 GHz, 1800 GHz, and 1900 GHz. Due to the limited band resources, some countries have opened the 850 GHz band for the GSM (2G) or GPRS (2.5G) systems. In the United States, the 850 GHz band is mainly used to enhance the network function in high-density areas of large cities. In South America, many countries only use the 850 GHz band. The quad-band mobile communication systems include the 850 GHz band to support multimedia applications, high-speed connections, and fast-speed audio and video data downloads. This helps toward the goal of global roaming for the mobile phones.

Besides, the mobile phone further combines the global positioning system (GPS) and its own mobile communication system to render the A-GPS mobile positioning technology. The basic operating principle of the A-GPS technology is based upon the GPS. The client holds a GPS-like device to receive satellite signals. The network has in addition a receiver for receiving signals. The positioning information is sent back to the client. Combining the information of the client and the network, the client is able to obtain more precise positioning result. This solves the problem of being unable to receive the GPS signals sometimes in the metropolitan area and indoor environment.

The A-GPS technology can combine with the current wireless communication network to implement the positioning function with higher precisions. However, the cost also soars as the functions become more complicated. Therefore, it is an important goal of the field to provide cheaper new-generation mobile phones that can integrate the A-GPS technology and the mobile communication technology on the same electronic device.

### SUMMARY OF THE INVENTION

Due to the advances in telecommunication technology, the communication standards in the world become more complicated. Therefore, it is an important objective for the mobile phone manufacturers to provide a new generation phone with better functions but at a lower cost.

An objective of the invention is to provide an intelligent mobile phone module with the CDMA, quad-band GSM, and A-GPS functions.

Another objective of the invention is to provide an intelligent mobile phone module that uses the 2G telecommunication basis and the 2G telecommunication functions to enhance the precision of positioning using the GPS function and network data.

In accord with the above-mentioned objectives, the invention discloses an intelligent mobile phone module that includes a main antenna, an assistant antenna, a switch, a first chipset (e.g. an RTR6275 chipset), a triplexer, and a second chipset (e.g. an RFR6500 chipset). The main antenna receives and transmits quad-band GSM signals (such as GSM850, GSM900, GSM1800, and GSM1900), CELL850 signals, and PCS1900 signals.

The assistant antenna assists to receive the CELL850 signals, PCS1900 signals and GPS1500 signals. The switch is coupled to the main antenna for selecting a desired input or output signal for the main antenna.

The first chipset is coupled to the switch for processing the input and output signals of the quad-band GSM signals and the output signals of CELL850 and PCS1900. The triplexer is coupled to an assistant antenna for selecting a desired input signal for the assistant antenna. The second chipset processes the CELL850, PCS1900, and GPS1500 input signals.

The intelligent mobile phone module further includes GSM850 and GSM900 filters coupled between the switch and the first chipset for extracting GSM850 input signals and GSM900 input signals, and GSM1800 and GSM1900 filters coupled between the switch and the first chipset for extracting GSM1800 input signals and GSM1900 input signals. For the assistant antenna, a PCS1900 filter is coupled between the triplexer and the second chipset for extracting PCS1900 input signals from the assistant antenna. A CELL850 filter is used to extract CELL850 input signals from the assistant antenna. Finally, a GPS1500 filter is used to extract GPS1500 input signals from the assistant antenna.

Besides, the second chipset can also use a PCS1900 filter and a CELL850 filter to respectively extract PCS1900 and CELL850 input signals from the main antenna.

Between the second chipset, the first chipset, and the switch, a CELL signal transceiver is used to switch between CELL850 signal transmission and reception. Moreover, a PCS signal transceiver is used to switch between PCS1900 signal transmission and reception.

For signal transmissions, the main antenna further includes a high-pass filter coupled between the first chipset and the switch for outputting high-frequency output signals, such as GSM1800 and GSM1900 output signals, to the main antenna. It may include a low-pass filter coupled between the first chipset and the switch for outputting low-frequency output signals, such as GSM850 and GSM900 output signals, to the main antenna.

This intelligent mobile phone module also uses a MSM6800 chipset to implement CDMA2000 1xEV-DO and to enhance its multimedia functions. In particular, the switch is a multi-point circuit switch, and the assistant antenna is a diversity antenna.

Therefore, the discloses intelligent mobile phone module integrates the second chipset, the first chipset, and the MSM6800 chipset to implement CDMA2000 1xEV-DO, to enhance its multimedia platform, and to eliminate the need for a co-processor. It further supports the transmission and reception of GSM850/900/1800/1900 signals, CELL850 signals, and PCS1900 signals. It also receives GPS signals from satellites. Therefore, the invention realizes a low-cost CDMA2000 1xEV-DOA and GSM dual-mode mobile phone. The GSM includes at least four commonly used bands and provides the A-GPS function.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 illustrates an intelligent mobile phone module in accordance with the embodiment of the present invention.

### DETAILED DESCRIPTION OF THE INVENTION

The present invention will be apparent from the following detailed description, which proceeds with reference to the accompanying drawing.

The disclosed intelligent mobile phone module utilizes the 2G telecommunication basis and 3G telecommunication functions, along with the GPS and network data, to greatly enhance the precision in positioning. The present invention will be apparent from the following detailed description, which proceeds with reference to the accompanying drawings, wherein the same references relate to the same elements.

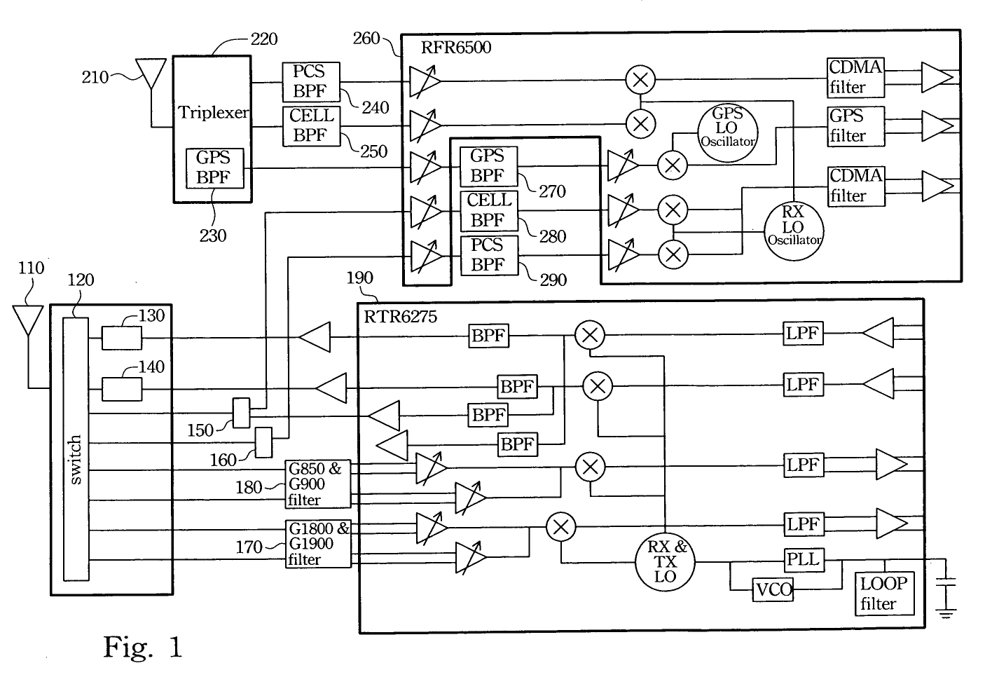

As shown in FIG. 1, the intelligent mobile phone module according to the invention includes a main antenna 110, a multi-point switch 120, an assistant antenna 210, a triplexer 220, an RFR6500 chipset 260, and an RTR6275 chipset 190. The base of the intelligent mobile phone module uses the Qualcomm MSM6800 chipset.

The main antenna 110 receives 850 GHz, 900 GHz, 1800 GHz, and 1900 GHz signals. It separates the 850 GHz and 900 GHz signals using a filter 170 and separates the 1800 GHz and 1900 GHz signals using a filter 180. It then transmits the signals to the RTR6275 chipset 190. The main antenna 110 also receives PCS 1900 (1900 GHz) signals and CELL 1500 (1500 GHz) signals and transmits them to the RFR6500 chipset 260. The assistant antenna 210 helps receiving PCS 1900 signals, CELL 1500 signals, and GPS 1500 (1500 GHz) signals. The received signals are then filtered respectively by a PCS band-pass filter 240, a CELL band-pass filter 230 and a GPS band-pass filter 250, and transmitted to the RFR6500 chipset 260. The triplexer 230 is used to switch the types of signals received by the assistant antenna 210 for each respective filter to extract and transmit to the RFR6500 chipset 260. The assistant antenna 210 in this embodiment is a diversity antenna.

Therefore, the disclosed intelligent mobile phone module can efficiently receive GSM850/900/1800/1900 signals and CELL850/PCS 1900/GPS 1500 signals.

When transmitting signals, the RTR6275 chipset 190 can send high-frequency signals (e.g., GSM 1800/1900 signals) via the high-pass filter 130 to the main antenna 110, and the low-frequency signals (e.g., GSM 850/900 signals) via the low-pass filter 140 to the main antenna 110. The CELL 850 signals are transmitted via a signal transceiver 150 to the main antenna 110. The PCS1900 signals are transmitted via a signal transceiver 160 to the main antenna 110 for transmitting signals to the base station. The CELL850 signals are transmitted or received via the signal transceiver 150. Their transmissions are performed using the main antenna 110. The transmissions of the PCS1900 signals are also achieved using the signal transceiver 160 and via the main antenna 110.

Since the signal transmissions of CELL850 and PCS1900 signals have been integrated on the RTR6275 chipset 190, the conventionally required RFT6150 chipset is no longer necessary. The cost of the mobile phone can thus be largely reduced.

The switch 120 is a multi-point circuit switch in order to switch among the input and output signals of different frequencies. The RFR6500 chipset 260 preferably includes a GPS band-pass filter 270, a CELL band-pass filter 280, and a PCS band-pass filter 290 for extracting the GPS signals from satellites and the CELL 850 and PCS1900 signals from the main antenna 110, respectively.

The disclosed intelligent mobile phone module uses the above-mentioned components and the MSM6800 chipset to implement CDMA2000 1xEV-DO for enhancing its multimedia platform and to eliminate the requirement of a co-processor. Under the RFR6500/RTR6275 structure, the invention supports the transmissions and receptions of GSM850/900/1800/1900 signals and CELL850 and PCS1900 signals as well. It can receive GPS signals from satellites as well. Therefore, the disclosed intelligent mobile phone module is a CDMA2000 1xEV-DOA and GSM dual-mode phone, produced at a lower cost. It is also a quad-band GSM phone that can provide the A-GPS function.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An intelligent mobile phone module, comprising:
a main antenna for receiving a quad-band GSM input signal, a first input signal, and a second input signal and transmitting a quad-band GSM output signal, a first output signal, and a second output signal;
an assistant antenna for helping receive the first input signal, the second input signal, and a GPS input signal;
a switch coupled to the main antenna for switching the main antenna between signal transmission and reception;
a first chipset coupled to the switch for processing the quad-band GSM input signal, the quad-band GSM output signal, the first output signal, and the second output signal;
a triplexer coupled to the assistant antenna for switching signal reception thereof; and
a second chipset coupled to the triplexer for processing the first input signal, the second input signal, and the GPS input signal.

2. The intelligent mobile phone module of claim 1, wherein the quad-band GSM output signal and input signal include GSM850, GSM900, GSM1800, and GSM1900 input and output signals.

3. The intelligent mobile phone module of claim 1 further comprising a GSM850 filter and a GSM900 filter coupled between the switch and the first chipset for extracting the GSM850 input signals and the GSM900 input signals.

4. The intelligent mobile phone module of claim 1 further comprising a GSM1800 filter and a GSM1900 filter coupled between the switch and the first chipset for extracting the GSM1800 input signals and the GSM1900 input signals.

5. The intelligent mobile phone module of claim 1 further comprising a PCS1900 filter coupled between the triplexer and the second chipset for extracting the second input signals from the assistant antenna.

6. The intelligent mobile phone module of claim 1 further comprising a CELL850 filter coupled between the triplexer and the second chipset for extracting the first input signals from the assistant antenna.

7. The intelligent mobile phone module of claim 1 further comprising a GPS1500 filter coupled between the triplexer and the second chipset for extracting the GPS input signals from the assistant antenna.

8. The intelligent mobile phone module of claim 1 further comprising a PCS1900 filter coupled to the second chipset for extracting the second input signals from the main antenna.

9. The intelligent mobile phone module of claim 1 further comprising a CELL850 filter coupled to the second chipset for extracting the first input signals from the main antenna.

10. The intelligent mobile phone module of claim 1 further comprising a CELL signal transceiver coupled among the second chipset, the first chipset, and the switch for switching between the reception of the first input signals and the transmission of the first output signals.

11. The intelligent mobile phone module of claim 1 further comprising a PCS signal transceiver coupled among the second chipset, the first chipset, and the switch for switching between the reception of the second input signals and the transmission of the second output signals.

12. The intelligent mobile phone module of claim 1 further comprising a high-pass filter coupled between the first chipset and the switch for outputting high-frequency output signals to the main antenna.

13. The intelligent mobile phone module of claim 12, wherein the high-frequency output signals include the GSM1800 output signals and the GSM1900 output signals.

14. The intelligent mobile phone module of claim 1 further comprising a low-pass filter coupled between the first chipset and the switch for outputting low-frequency output signals to the main antenna.

15. The intelligent mobile phone module of claim 1, wherein the low-frequency output signals include the GSM850 output signals and the GSM900 output signals.

16. The intelligent mobile phone module of claim 1 further comprising an MSM6800 chipset for implementing CDMA2000 1xEV-DO and enhancing its multimedia functions.

17. The intelligent mobile phone module of claim 1, wherein the switch is a multi-point circuit switch.

18. The intelligent mobile phone module of claim 1, wherein the assistant antenna is a diversity antenna.

19. The intelligent mobile phone module of claim 1, wherein the first input signal is a CELL 850 input signal and the second output signal is a CELL850 output signal.

20. The intelligent mobile phone module of claim 1, wherein the second input signal is a PCS1900 input signal and the second output signal is a PCS1900 output signal.
